(19) United States
(12) Patent Application Publication
(10) Pub. No.: US 2002/0025796 A1
(43) Pub. Date: Feb. 28, 2002

(54) System and method conducting cellular POS transactions

(76) Inventors: William Stuart Taylor, Cupertino, CA (US); Jean-Marc Villaret, Paris (FR); Kevin Ritschel, San Jose, CA (US)

Correspondence Address: HEWLETT-PACKARD COMPANY, Intellectual Property Aministration, P.O. Box 272400, Fort Collins, CO, 80527-2400, US

(21) Appl. No.: 09/850,802

(22) Filed: May 8, 2001

Related U.S. Application Data
(60) Provisional application No. 60/229,564, filed on Aug. 30, 2000.

(51) Int. Cl. H04M 11/00

(52) U.S. Cl. 455/406; 455/414; 455/558

(57) ABSTRACT

A method for conducting POS transactions with a cellular POS device while remotely located from a merchant location or from a payment authorizing data processing system (DPS). In one example embodiment, a cellular telephone point-of-sale device includes a mobile cellular telephone having a housing for an integrated display, keypad and communications unit. The communications unit includes a communications processor arrangement, a card reading device configured and arranged to receive customer-specific financial account data from a customer identification card and an application specific circuit arrangement coupled to the card reading device. The processor arrangement is adapted to be programmed to verify the integrity of a sales transaction using the customer-specific financial account data.

### RELATED PATENT DOCUMENTS

This application claims priority to U.S. Provisional Application Ser. No. 60/229,564, filed on Aug. 30, 2000 (10004387-1), entitled “Cell Phone POS Device.”

### FIELD OF THE INVENTION

The present invention generally relates to Point of Sale (POS) transactions, and more particularly to conducting POS transactions using a wireless communications network.

### BACKGROUND OF THE INVENTION

Automated teller machines and Electronic Funds Transfer Point of Sale (EFTPOS) terminals have operated for many years. Most current EFTPOS devices function in the same manner in that the account details are input into the device, along with an account type and P.I.N. (personal identification number), and the information is sent to a bank or financial institution for authorization. Once authorization is received the transaction continues until completion, for example, by cash received or receipt of article purchased is received and receipt tendered.

In a retail scenario, a customer typically finishes shopping and takes all of the goods to be purchased to a clerk or cashier at a checkout line that includes a cash register. Once all of the goods have been logged into the system for payment, the customer typically tenders payment via a charge card or credit card. A POS device owned by the merchant is positioned adjacent the cash register and is used to process payment based on the account information on the card. Account information, that includes the credit card account number, is processed once an authorization code is inputted into the system. The data is sent via a dial up modem system through leased lines that have a permanent connection to a transaction switching network where it is sent through the customer's bank's host computer to obtain bank authorization. The merchant's bank is also involved in the processing system in order to coordinate the transfer of funds from the customer's bank to the merchant's bank.

Most of the purchase transactions today that utilize the EFTPOS system are limited to merchants having fixed in-store (or facility) installations. This is, however, costly infrastructure and fixes the location of the merchant POS device. Any movement of a POS device from one location to another will have an accompanying telephone line installation. Another payment system approach utilizes authorization by telephone where the merchant actually calls into the customer's credit card company for real-time authorization of the transaction. Unfortunately, this approach is not only time consuming but does not provide a single receipt with most of the purchase and account details conveniently displayed.

A method and a system that address the aforementioned problems, as well as other related problems, are therefore desirable.

### SUMMARY OF THE INVENTION

The present invention is directed to addressing the above and other needs in connection with conducting POS related transactions while providing mobility and lower initial investments in merchant POS payment systems.

According to one aspect of the invention, a cellular telephone point-of-sale device includes a mobile cellular telephone having a housing for an integrated display, keypad and communications unit. The communications unit includes a communications processor arrangement, a card reading arrangement configured and arranged to receive customer-specific financial account data from a customer identification card and an application specific circuit arrangement that is coupled to the card reading device. The processor arrangement is adapted to be programmed to verify the integrity of a sales transaction using the customer-specific financial account data.

According to another aspect of the invention, a method of using a cellular device in a POS transaction between a sales person and a customer includes using a mobile communications device for processing data for cellular communications. The mobile communications device includes an arrangement for displaying and inputting data. Customer-specific financial account data is received from a customer identification card and payment authorization is requested pursuant to a purchase order via the mobile communications device using the customer-specific financial account data. Payment authorization status is received via the mobile communications device for the purchase order via an authorizing DPS at a financial institution that uses the customer-specific financial account data to determine payment status.

It will be appreciated that various other embodiments are set forth in the Detailed Description and claims that follow.

### BRIEF DESCRIPTION OF THE DRAWINGS

Various aspects and advantages of the invention will become apparent upon review of the following detailed description and upon reference to the drawings in which:

FIG. 1 illustrates a block diagram of a cellular POS transaction system in accordance with an example embodiment of the invention;

FIG. 2A is a block diagram of a cellular POS transaction device in accordance with an example embodiment of the invention; and

FIG. 2B is a block diagram of a cellular POS transaction device in accordance with another example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described in connection with mobile cellular devices that facilitate mobility and lower infrastructure costs of implementing POS transaction systems. Those skilled in the art will appreciate that the invention could be implemented in a variety of programming languages and hardware platforms.

In an example embodiment, a POS transaction system including a payment requesting DPS (data processing system) and a cellular communications network facilitates commercial transactions that occur remote from a fixed retail location or a financial institution. The system includes a mobile communications device for processing data for cellular communications that includes a data display and a data-keying device. The system also includes an arrangement for reading and receiving customer-specific financial account data from a customer identification card that is coupled to the mobile communications device. The mobile communications device also verifies the integrity of a sales transaction using the customer-specific financial account data and communicates the customer-specific account data via the cellular network to the payment requesting DPS. A payment authorizing DPS adapted to use the customer-specific account data received from the payment requesting DPS to verify payment ability of the customer and to send payment ability verification to the mobile communications device via the cellular network.

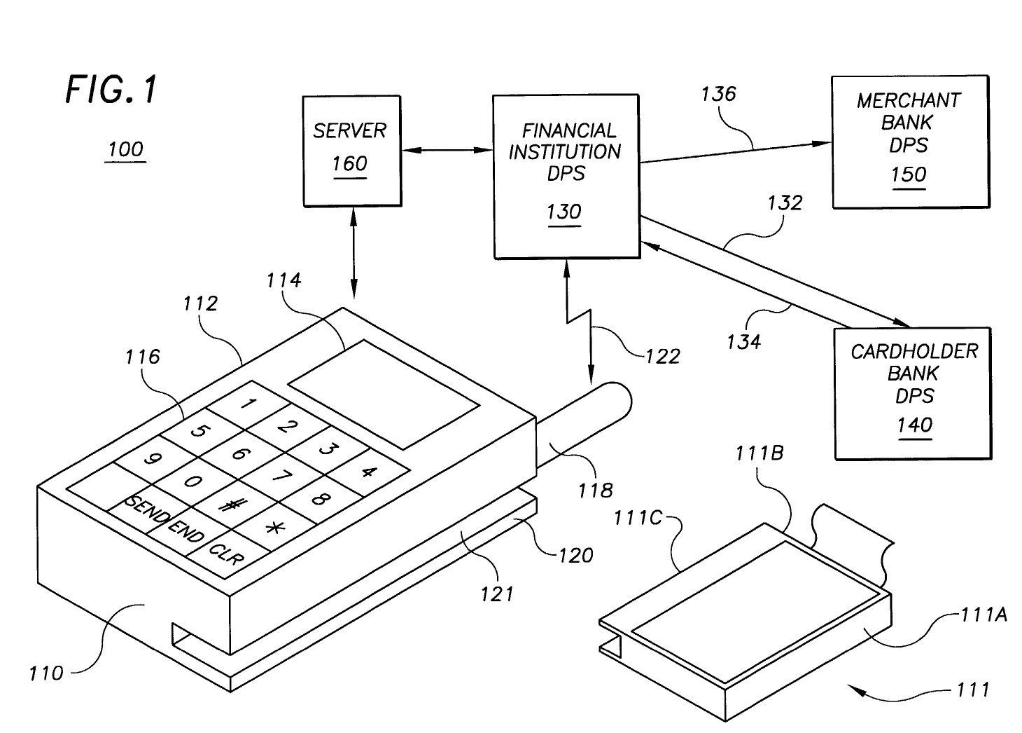

Referring now to the figures, FIG. 1 illustrates a block diagram of the cellular POS transaction system 100 in accordance with an example embodiment of the invention. POS transaction system 100 includes a cellular telephone POS device 110, a financial institution DPS 130 that hosts a financial application, a cardholder bank DPS 140 that hosts a cardholder application and a merchant bank DPS 150 hosting a merchant bank application. POS device 110 is a conventional cellular-type telephone modified, according to the present invention, to read a credit card and to process customer-specific financial account data that is tendered in connection with authorizing payment in a sales transaction. Thus, the POS device 110 includes a housing 112, a processor arrangement adapted to be programmed to verify the integrity of a sales transaction using the customer account data, a display 114, a keypad 116, an antenna 118 and a card reader 120. In this example embodiment, card reader 120 is a magnetic stripe reader that is adapted to read data from the magnetic stripe located on most credit or charge cards. In another example embodiment, card reader 120 includes a slot for reading smart cards that have integrated chips located thereon. POS device 110 is also adapted to handle various displaying options, to process data and to establish cellular communication when on a sales call with a customer.

In an example application, a clerk or cashier uses cellular POS device 110 in a retailing location as they are performing customer service duties in the store. Once a customer has completed his shopping, the customer tenders selected goods to the cashier for logging of the purchases into a merchant purchasing system (not shown). In a related embodiment, the POS device is used to check or log in purchases where the customer has only one or two items. The purchases are logged into the POS device using the keypad or a barcode reading device coupled to the POS device. Once all the goods have been logged into the system, the customer proceeds to pay with a store charge card or a bank issued credit card. Once prompted by display 114, the clerk then proceeds to swipe or slide the card (or otherwise present data) for the card reader 120 in order to gather customer-specific account information, which in this case corresponds to the credit card account number and issuing bank identification number. Magnetic card reader 120 has a corresponding magnetic stripe 121 that couples with the magnetic card stripe on the card for reading the account information.

For additional security, the customer is requested to input a security code, such as a personal identification number, via keypad 116 that will accompany an authorization for payment request. Once the account information and security code have been inputted POS device 110, via display 114, can indicate that the information has been properly keyed in and is ready to seek authorization. In this example application, the customer is given a final opportunity to decide on whether to consummate the purchase before the payment authorization is requested. Display 114 is also available for displaying the sales transaction or for verifying the items purchased as an added customer feature. In another application, the authorization is requested immediately after the security code is keyed into device 110. POS device 110 then proceeds to establish a cellular communications link 122 with DPS 130 of the financial institution in the form of a cellular telephone call through the cellular communications network via antenna 118. The clerk continues to wait until display 114 indicates the status of the transaction (approved, denied or aborted) before proceeding further with the transaction.

In order to commence the payment authorization process, POS device 110 establishes communications with DPS 130 via communications link 122. DPS 130 acts to verify and authorize payment (the transfer of funds) from DPS 140 at the cardholder financial institution and DPS 150 at the merchant financial institution. In a related embodiment, DPS 150 at the merchant financial institution replaces DPS 130 in verifying and authorizing payment from DPS 140, which serves to streamline the authorization process by eliminating another stage in the authorization process. DPS 130 first sends data requesting payment authorization via a communications link 132 from DPS 140 at the cardholder financial location. DPS 140 promptly accesses a database (not shown) to determine the cardholder's credit line, or funds availability if using a debit card, and then proceeds to send a second set of data in response to the initial authorization request via a return communications line represented by line 134. Assuming that the transaction is approved, DPS 130 then sends a third set of data communicating to DPS 150 at the merchant financial institution that the funds are being transferred and the transaction is approved. DPS 130 immediately thereafter sends a fourth set of data representing a sales transaction and payment approval back to the retail location via POS device 110. Once the transaction is approved, display 114 indicates the approval and the clerk continues to finalize the transaction, such as tendering goods, describing guarantee and return policies, etc. Where there is an interruption in the initial call or the authorization process is aborted, the merchant can chose to include in the POS transaction software a feature for repeating automatically the authorization calling sequence so as not to unnecessarily inconvenience the customer.

In a related application, the POS device is used by a sales person to conduct sales transactions in locations remote from the store or warehouse or is used by a mobile merchant that transports his goods as part of the service provided. POS device 110 includes logic and software that provides the capability of simulating an EFTPOS terminal. POS device 110 uses the display and connectivity of cellular technology to communicate with the DPS at an authorizing bank from a remote location and displays the result of the authorization and sales transaction to the customer immediately. This will enable home service providers and delivery people to secure payment immediately, thereby reducing paperwork and eliminating collection issues.

In another related embodiment, sales calls are turned into immediate purchase orders and actual paid sales since a sale is consummated while the customer is still on the phone. POS device 110 is used to call a customer from a remote location where a sales person is traveling and is away from the office. Upon reaching an agreement with the customer on a particular order, the sales person simply inputs the account information via keypad 116 (by implementing an alternate function key to avoid call termination) and sends the transaction data via the cellular network to a data processing system (DPS) at a financial institution for authorization. Issues of security of the actual transaction data can be managed by placing a hold on customer funds for a predetermined period of time, such as 24 hours, to allow the customer time to review the transaction to ensure the funds were taken out properly. The transaction is subject to certain monetary limits and/or limited to personnel authorized to make such contractual commitments as examples of improving security in these transactions.

Conducting POS transactions via a cellular POS device has the advantage of not locking payment transactions into currently available but costly private or licensed protocol payment authorization systems. In addition, the approach of the present invention avoids the pitfalls of current mobile systems offered today that are bulky and require large, heavy batteries to operate elaborate printing systems. The mobile systems offered today make it cumbersome to conduct business and difficult to carry with you on business travel.

In another embodiment, POS device 110 is a combination of a cellular telephone and a snap-on module 111 that includes a magnetic stripe reader 111A (or a smart card reader or a chip card reader). Module 111 includes a printer 111B that is integral with the module (module 111 could provide a printer interface for coupling the module to a printer). In addition, snap-on module 111 includes an interface 111C that provides a communication link with the cellular telephone of POS device 110. The interface could communicate via infrared, low power radio communications or via a direct cable link. In another embodiment, system 100 further includes a proxy server 160 that includes a payment application for running all of the payment tasks on the merchant's premises or at a nearby location before sending the information to DPS 130 for payment processing. The system could be easily upgraded by upgrading the application software of proxy server 160, while the hardware in the system would remain the same.

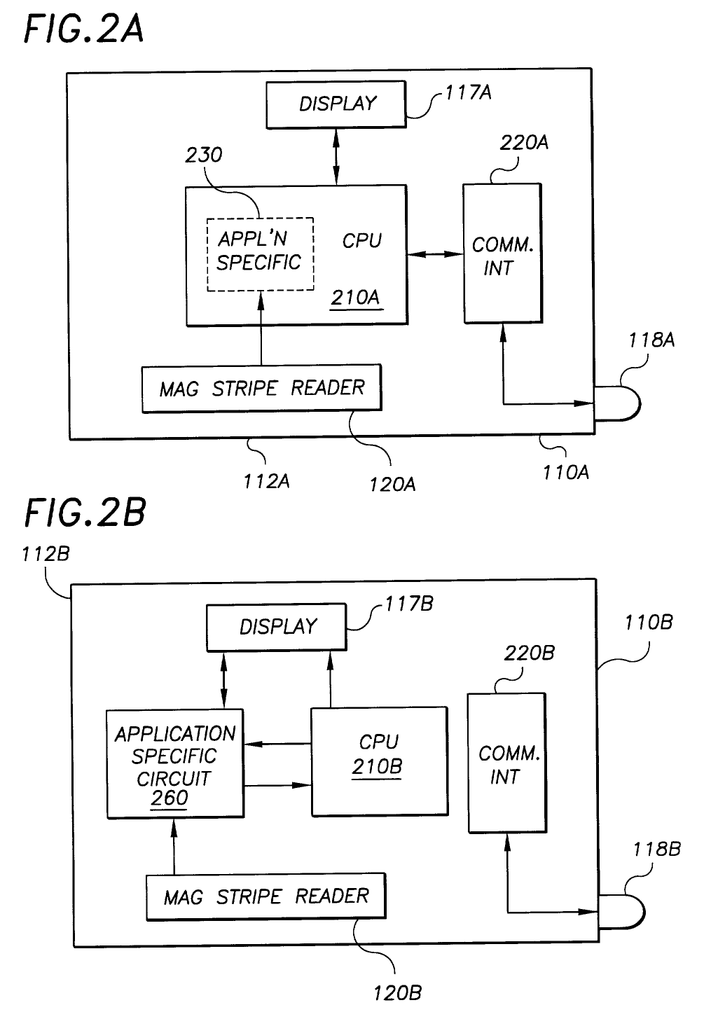

Referring now to FIG. 2A, an example embodiment of POS device 110A is illustrated in accordance to the invention. In particular, POS device 110A includes a CPU 210A inside housing 112A that is coupled to a communications interface 220A and to a display 117A. Communications interface 220A is coupled to antenna 118A for cellular communications. Device 110A further includes a card reading device 120A that is coupled to CPU 210A and is adapted to receive customer-specific account information, when a credit card is presented, and send it to CPU 210A. In this embodiment, device 110A further includes an application specific circuit 230 (e.g., an ASIC integrated into CPU 210A) for processing the financial information data received from the customer through the magnetic stripe reader 120A and received back via communications interface 220A from a DPS located at the financial institution. Circuit 230 is programmed to control display 117A, the keypad and card reading device 120A of the POS device 110A. In one example embodiment, POS device 110A is a PCS or cellular telephone device with CPU 210A and communications interface 220A adapted conventionally with the exceptions of the device 230A and related programming, as discussed above.

Referring now to FIG. 2B, another example embodiment of a POS device 110B is illustrated in accordance to the invention. In particular, POS device 110B includes a CPU 210B inside housing 112B that is coupled to a communications interface 220B and to a display 117B. Communications interface 220B is coupled to antenna 118B for cellular communications. Device 110B further includes a card reading device 120B that is coupled to CPU 210B and is adapted to receive customer-specific account information when the credit card is presented. In this embodiment, device 110B further includes stand-alone application specific chip 260 (which in this example is a Verifone chip) that is coupled to CPU 210B and to display 117B. Chip 260 is adapted to process the financial information data received from the customer via magnetic stripe reader 120B and to receive data back from a DPS located at the financial institution via communications interface 220A. In a related embodiment, functionality of chip 260 is integrated into the magnetic reader 120B hardware.

In a related embodiment, the cellular POS device is a WAP (Wireless Application Protocol) mobile phone capable of interacting with a Bluetooth™-enabled wireless wallet having a smart card/credit card therein. Using the WAP phone allows the customer to pay for his purchases without removing the wallet from his pocket. The Bluetooth protocol uses wireless data and voice transmission that uses radio technology to communicate with a smart card reader in the wallet. When a smart card is inserted into the wallet, it can communicate with the Bluetooth-enabled mobile phone. From the WAP mobile phone the transaction data is sent via an RF signal to a WAP-Gateway which then re-transmits the data to a WAP Server. The WAP Server transmits the data via the cellular network to establish the connection with the authorizing DPS located at the financial institution.

Various embodiments of the invention are believed to be applicable to a variety of POS payment authorization and transaction systems. The present invention has been found to be particularly applicable and beneficial in scenarios involving POS transactions that are conducted in the customer's presence. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A cellular telephone point-of-sale device, the device comprising:
a mobile cellular telephone including a housing for an integrated display, keypad and communications unit, the communications unit including a communications processor arrangement, a card reading arrangement configured and arranged to receive customer-specific financial account data from a customer identification card and an application specific circuit arrangement for interfacing with the card reading arrangement, the processor arrangement being programmable to verify the integrity of a sales transaction using the customer-specific financial account data.

2. The device of claim 1, wherein the card reading arrangement includes a module coupled to the mobile cellular telephone that receives customer-specific financial account data from the customer identification card and transmits the account data to the cellular telephone.

3. The device of claim 2, wherein the card reading arrangement includes:
a magnetic stripe reading device; and
a strip slot adapted to guide the identification card while the magnetic stripe is being read.

4. The device of claim 1, wherein the application specific circuit arrangement includes an integrated chip that is communicatively coupled with a cellular data processing circuit.

5. The device of claim 1, wherein the mobile cellular telephone includes a WAP mobile phone adapted to communicate with a WAP network.

6. A cellular point-of-sale communications device, the device comprising;
mobile communications means including means for displaying and inputting data for processing data for cellular communications; and
means for reading and receiving customer-specific financial account data from a customer identification card coupled to the mobile communications means and coupled to an application specific circuit means for verifying the integrity of a sales transaction using the customer-specific financial account data.

7. A cellular telephone point-of-sale device, the device comprising:
a mobile cellular telephone including a housing for integrating a display, a keypad and a communications unit, the communications unit including a communications processor arrangement, a memory arrangement, a card reading arrangement configured and arranged to receive customer-specific financial account data from a customer identification card and an application specific circuit arrangement adapted to interface with the card reading arrangement, the memory arrangement having a program stored therein, when executed, causes the processor arrangement to verify the integrity of a sales transaction using the customer-specific financial account data.

8. The device of claim 7, wherein the interface includes:
a magnetic stripe reading device; and
a strip slot adapted to guide the identification card while the magnetic stripe is being read.

9. The device of claim 7, wherein the interface includes a magnetic stripe reading device and a strip slot adapted to guide the identification card while the magnetic stripe is being read, and wherein the application specific circuit arrangement includes an integrated chip adapted and configured to process financial account data received from the customer via the magnetic stripe reading device and adapted to receive data back from a DPS, the processor arrangement communicatively coupled with a cellular data processing circuit.

10. A method of using a cellular point of sale device to transmit financial data to a remote DPS, the method comprising:
using mobile communications means including means for displaying and inputting data for processing data for cellular communications; and
reading and receiving customer-specific financial account data from a customer identification card and verifying via an application specific circuit means the integrity of a sales transaction using the customer-specific financial account data and the remote DPS.

11. The method of claim 1 0, wherein the step of receiving customer-specific financial account data includes reading a magnetic stripe from the customer identification card.

12. The method of claim 10, wherein the step of receiving customer-specific financial account data includes the steps of:
reading a magnetic stripe from the customer identification card; and
guiding the customer identification card as the magnetic stripe is being read.

13. The method of claim 10, wherein the step of verifying the integrity of a sales transaction includes communicatively coupling an application specific chip with a cellular data processing circuit to transmit the customer-specific financial account data.

14. A method of using a cellular device in a point of sales transaction between a sales person and a customer, the method comprising:
using mobile communications means including means for displaying and inputting data for processing data for cellular communications;
receiving customer-specific financial account data from a customer identification card and transmitting payment authorization request pursuant to a purchase order via an application specific circuit arrangement and the mobile communications means using the customer-specific financial account data; and
receiving via mobile communications means a payment authorization status for the purchase order via an authorizing DPS that uses the customer-specific financial account data for determining payment authorization status.

15. The method of claim 14, before the step of receiving customer-specific account data, including the step of logging a set of purchases by the customer in a retail location.

16. The method of claim 14, where the step of receiving customer-specific account data further includes the steps of logging a purchase from the customer and transmitting the customer-specific account data to a remote authorizing DPS for securing payment authorization via mobile communications means.

17. A POS transaction system including a payment requesting DPS and a cellular communications network, the system comprising:
mobile communications means including means for displaying and inputting data for processing data for cellular communications;
means for receiving customer-specific financial account data from a customer identification card coupled to the mobile communications means and coupled to an application specific circuit arrangement for verifying the integrity of a sales transaction using the customer-specific financial account data, the mobile communications means also for communicating the customer-specific account data via the cellular network to the payment requesting DPS; and
a payment authorizing DPS adapted to use the customer-specific account data received from the payment requesting DPS for verifying payment ability of the customer and sending payment ability verification to the mobile communications means via the cellular network.

18. The system of claim 17, further comprising a payment receiving DPS located at a merchant financial institution adapted to receive the payment ability verification from the payment authorizing DPS.

19. The system of claim 18, wherein means for receiving customer-specific account data includes a magnetic stripe reader adapted to read customer-specific account data from the customer identification card.

20. The system of claim 18, wherein means for receiving customer-specific account data includes a magnetic stripe reader and a strip slot adapted to guide the identification card while a magnetic stripe on the card is being read, and wherein the mobile communications means includes an application specific circuit arrangement configured and arranged to process financial account data received from the customer via the magnetic stripe reading device and adapted to receive data back from the payment authorization DPS, and wherein the mobile communications means is communicatively coupled with a cellular data processing circuit.

21. The system of claim 17, wherein means for receiving customer-specific account data includes a proxy server that hosts a payment application that processes the customer-specific account data before transmitting the data to the payment authorizing DPS.

22. The system of claim 17, wherein means for receiving customer-specific account data includes a module that is coupled to mobile communications means and is receives the customer-specific account data from the customer identification card.

23. The system of claim 6, wherein means for receiving customer-specific account data includes a module that is coupled to mobile communications means and is receives the customer-specific account data from the customer identification card.
